(19) United States
(12) Patent Application Publication
(10) Pub. No.: US 2010/0067881 A1
(43) Pub. Date: Mar. 18, 2010

(54) AUDIO/VIDEO SIGNAL ACCESS CONTROLLING APPARATUS

(76) Inventor: Li-Chun Lai, Panciao City (TW)

Correspondence Address: SINORICA, LLC, 2275 Research Blvd., Suite 500, ROCKVILLE, MD, 20850, US

(21) Appl. No.: 12/210,705

(22) Filed: Sep. 15, 2008

(51) Int. Cl. H04N 7/26

(52) U.S. Cl. 386/124

(57) ABSTRACT

An AV signal access controlling apparatus is provided and mainly comprises an exterior connector being connected to a controller, a voltage level generator, a S connector (independent video connector), a RCA (Radio Corporation of America) connector, and an USN connector. When the exterior connector is connected to an AV storage apparatus, the voltage level generator outputs a voltage level to the AV storage device and a voltage level comparison proceeds. Thus the AV storage apparatus permits to proceed signal transmission with the controller. When the controller is configured to transmit signals to the AV storage apparatus, a delay of 51μ second (51 μs) is required for simulating a transmission rate of 19200 bps, thus the AV storage apparatus permits to transmit the audio and video signals via the S connector, the RCA connector, or the USB connector.

### BACKGROUND OF THE INVENTION

1. Field of the Invention

The present invention relates to an audio/video (AV) signal access controlling apparatus. More particularly, the present invention relates to an AV signal access controlling apparatus being configured to simulate voltage level data and transmit signals by a simulated transmission rate to make the AV storage apparatus output the audio and video signals, wherein the voltage level data is recognized by the AV storage apparatus.

2. Description of the Prior Art

I-POD, I-PHONE and AV storage apparatuses are all configured to provide functions of sounds, images, or pictures storage, and the user can store audio/video files or pictures conveniently at any time.

Although the conventional I-POD, I-PHONE and AV storage apparatuses are able to store audio/video files or pictures, they still have the following drawbacks.

The conventional I-POD, I-PHONE and AV storage apparatuses are usually equipped with coding settings, thus the audio/video files can only be displayed on the display of a particular machine. Once trying to display the audio/video files on an exterior display apparatus via data transmission, a particular audio/video access apparatus is usually required and has to purchase from vendors. Thus, the vendors may monopolize the market and raise the price of AV signal access controlling apparatus, which costs user's economic burden.

Thus it can be seen that the aforementioned conventional products still have many drawbacks and are not good in design, thus the aforementioned products need improvement.

The inventor considers improvement in view of the aforementioned drawbacks of the conventional products, and develops the present invention of AV signal access controlling apparatus after a long term of research.

### SUMMARY OF THE INVENTION

The primary objective of the present invention is to provide an AV signal access controlling apparatus. The AV signal access controlling apparatus is configured to simulate voltage level data for the AV storage apparatus to make the AV storage apparatus process data transmission with the controller. The AV signal access controlling apparatus is configured to simulate a transmission rate, thus the AV storage apparatus permits to transmit the audio and video signals to an exterior display apparatus for displaying.

Another objective of the present invention is to provide an AV signal access controlling apparatus. The AV signal access controlling apparatus operates with simple circuitry and software and is characterized in low manufacturing cost, thus economic loading of the users can be reduced.

The AV signal access controlling apparatus being able to achieve the aforementioned objectives comprises a controller, a reset unit, an oscillator, a voltage level generator, an exterior connector, a S connector, a RCA connector, and an USB connector.

Wherein the reset unit is coupled to the oscillator and the controller, and the controller, the voltage level generator, the S connector, the RCA connector, and the USB connector are all connected to the exterior connector. When the exterior connector is connected to a AV storage apparatus, a voltage level is provided to the AV storage apparatus by the voltage level generator. When the AV storage apparatus determines that the voltage level is correct, signal transmission with the controller is permitted. When the controller is configured to transmit signals to the AV storage apparatus, a delay of 51μ second (51 μs) is required for simulating a transmission rate of 19200 bps, thus the AV storage apparatus permits to transmit the audio and video signals to an exterior display apparatus for displaying via the S connector, the RCA connector, or the USB connector.

These features and advantages of the present invention will be fully understood and appreciated from the following detailed description of the accompanying Drawings.

### BRIEF DESCRIPTION OF THE DRAWINGS

FIG. 1 illustrates a block diagram of the AV signal access controlling apparatus of the present invention;

FIG. 2 illustrates a circuitry diagram of the AV signal access controlling apparatus of the present invention;

FIG. 3 illustrates a flow chart of signal transmission from the controller of the AV signal access controlling apparatus of the present invention;

FIG. 4 illustrates a flow chart of the AV signal access controlling apparatus of the present invention; and

FIG. 5 illustrates a time diagram of the AV signal access controlling apparatus of the present invention.

### DETAILED DESCRIPTION OF THE PREFERRED EMBODIMENT

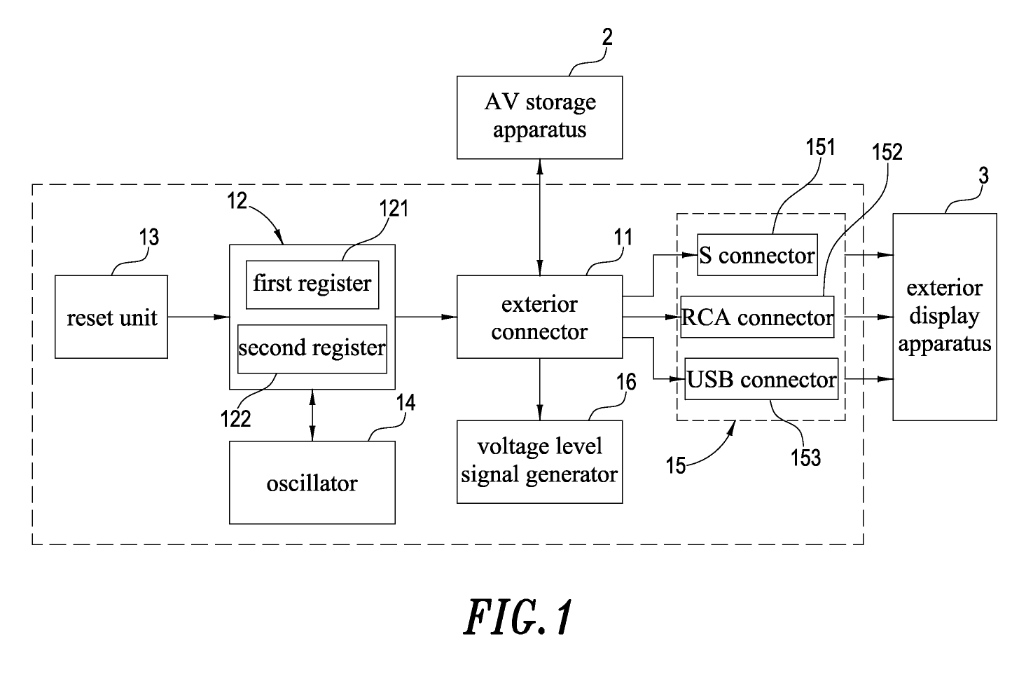

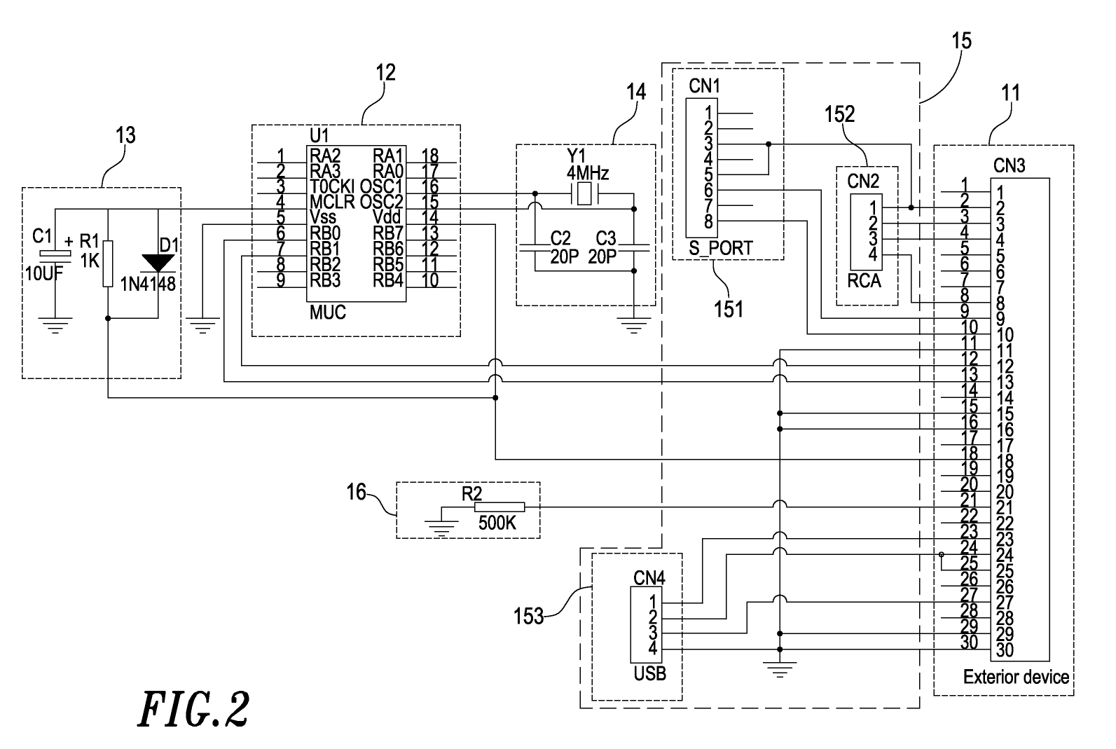

FIGS. 1 and 2 illustrate the AV signal access controlling apparatus of the present invention mainly comprising the following devices.

The AV signal access controlling apparatus comprises an exterior connector 11, being connected to an exterior AV storage apparatus 2. The AV signal access controlling apparatus comprises a controller 12 being connected to the exterior connector 1. A first register 121 and a second register 122 are set inside the controller 12. A plurality of output signal sets Y are set inside the controller 12, in which each output signal set Y comprises a plurality of clock signals N. The first register 121 is configured to register the output signal sets Y, and the second register 122 is configured to register the clock signals. Therefore, the controller 12 is configured to transmit each clock signal N contained in each output signal set Y to the AV storage apparatus 2, and to determine whether a feedback signal from the AV storage apparatus 2 is received. The controller 12 is configured to differentiate and process the received signals.

The AV signal access controlling apparatus comprises a reset unit 13 being connected to the controller 12. When the controller 12 is inactive, the reset unit 13 is configured to reset the controller 12 and reactivate the controller 12.

The AV signal access controlling apparatus comprises an oscillator 14 being connected to the controller 12. The oscillator 14 is configured to oscillate the outputted signal of the controller 12 as a clock signal N, and to output the clock signal N to the AV storage apparatus 2.

The AV signal access controlling apparatus comprises a connector set 15 having a S connector 151, a RCA connector 152, or an USB connector 153. The S connector (independent video connector) 151, the RCA connector (Radio Corporation of America connector) 152, and the USB connector 153 are connected to the exterior connector 11.

The AV signal access controlling apparatus comprises a voltage level signal generator 16. The voltage level signal generator 16 is connected to the exterior connector 11 and provides a voltage level signal to the AV storage apparatus 2 for proceeding a voltage level comparison. The voltage level signal is generated by a 500KΩ resistor. Once the voltage level is correct, the AV storage apparatus 2 is able to process signal transmission with the controller 12.

Besides, the AV storage apparatus 2 is configured to provide power supply to the controller 12, the reset unit 13, and the oscillator 14 for normally operating the controller 12, the reset unit 13, and the oscillator 14.

Besides, the USB connector 153 is configured to be connected to the power supply for charging the AV storage apparatus 2.

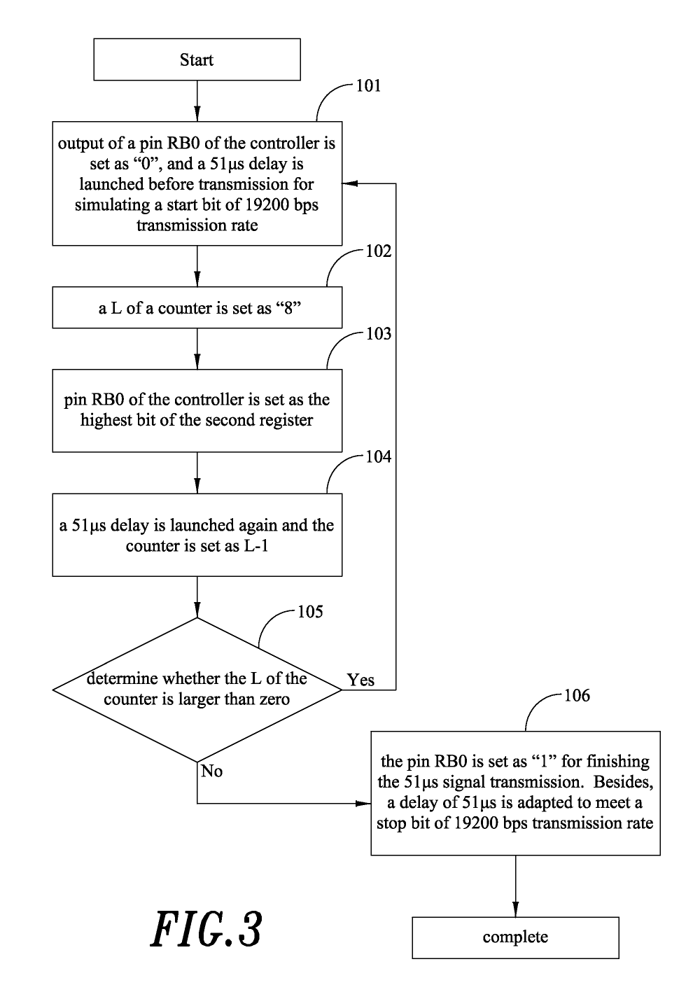

FIGS. 2 and 3 illustrate flow charts of signal transmission from the controller of the present invention. First, output of a pin RB0 of the controller is set as “0”, and a 51 μs delay is launched before transmission for simulating a start bit of 19200 bps transmission rate (101). Then a L of a counter is set as “8” (102). Then the pin RB0 of the controller is set as the highest bit of the second register (103). Then a 51 μs delay is launched again and the counter is set as L−1 to achieve the objective of transmission proceeded from a high bit to a low bit (104). A step is executed to determine whether the L of the counter is larger than zero (105). If the L is larger than zero, then the pin RB0 is set as the highest bit of the second register (103). If the L is smaller than zero, then the pin RB0 is set as “1” for finishing the 51 μs signal transmission. Besides, a delay of 51 μs is adapted to meet a stop bit of 19200 bps transmission rate (106). Thus, the signal transmission is finished.

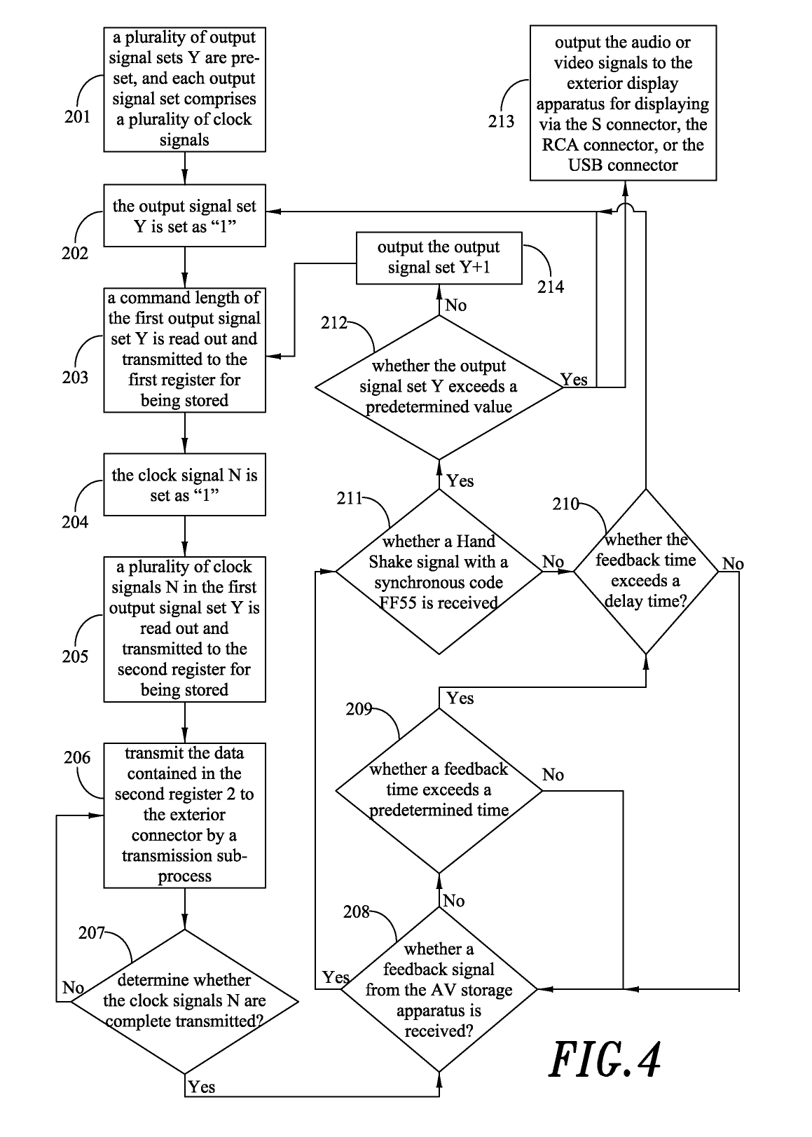

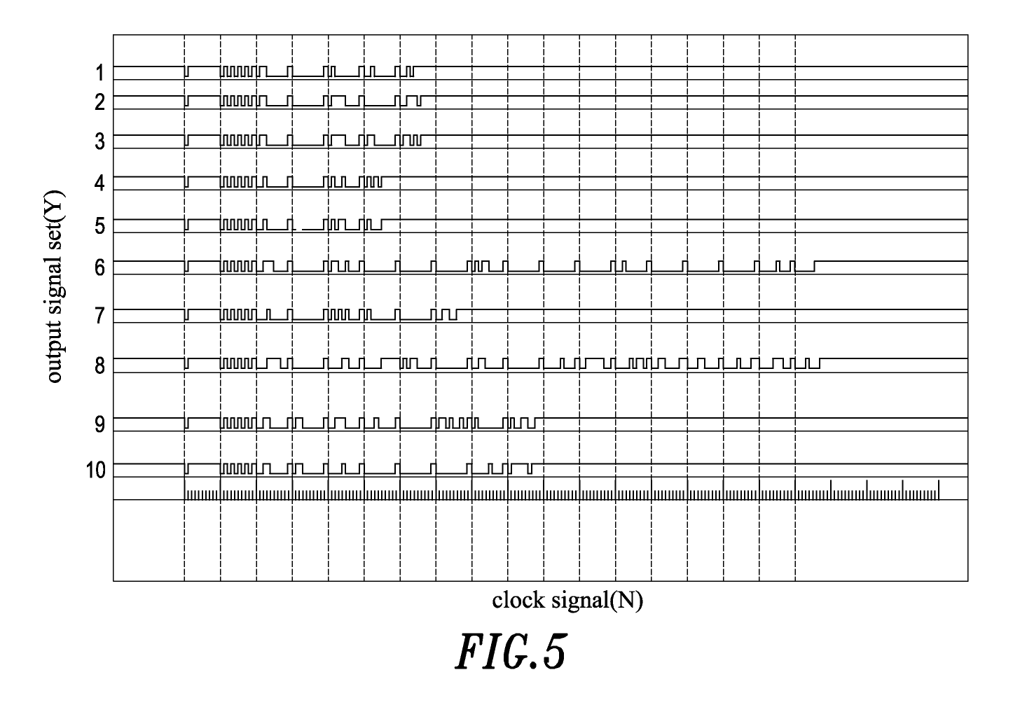

FIGS. 4 and 5 illustrate flow charts of the present invention. When the AV storage apparatus is connected to the exterior connector, the voltage level generated by the voltage level generator is checked first. If the voltage level is correct, the signal transmission with the controller is permitted. The controller is pre-set with a plurality of output signal sets Y, and each output signal set comprises a plurality of clock signals (201). Then, the output signal set Y is set as “1” (202). And a command length of the first output signal set Y is read out and transmitted to the first register for being stored (203). Then the clock signal N is set as “1” (204). A plurality of clock signals N in the first output signal set Y is read out and transmitted to the second register for being stored (205). Then the plurality of clock signals N in the second register is transmitted to the AV storage apparatus one by one under N+1 mode, as described in the aforementioned signal transmission process shown in FIG. 3 (206). Then a step is executed to determine whether the clock signals N are complete transmitted (207). If the clock signals N are not complete transmitted, then the clock signals N are continuously transmitted (206). If the clock signals N are complete transmitted, a step is executed to determine whether a feedback signal from the AV storage apparatus is received (208). If the feedback signal from the AV signal access controlling apparatus is not received, then a step is executed to determine whether a feedback time exceeds a predetermined time (209). If the feedback time does not exceed the predetermined time, then the process keeps waiting (208). If the feedback time exceeds the predetermined time, then a step is executed to determine whether the feedback time exceeds a delay time (210). If the feedback time exceeds the delay time, then the process goes back to the output signal set Y being set as “1”. When the feedback signal from the AV storage apparatus is received within the determined time or the delay time, a step is executed to determine whether a handshaking signal is received (211). If the handshaking signal is not received, then a step is executed to determine whether the feedback time exceeds a delay time (210). If the Hand Shake signal is received, then a step is executed to determine whether the output signal set Y exceeds a predetermined value (212). If the output signal set Y exceeds the predetermined value, then the audio or video signals are outputted to the exterior display apparatus for displaying via the S connector, the RCA connector, or the USB connector (213). If the output signal set Y does not exceed the predetermined value, then the output signal set Y+1 is outputted (214). Then a command length of the first output signal set Y is read out and transmitted to the first register for being stored (203).

The AV signal access controlling apparatus of the present invention, comparing with other conventional technologies, is advantaged as follows.

1. The present invention is configured to simulate voltage level data of the AV storage apparatus to ensure the AV storage apparatus permit to proceed data transmission with the controller. The present invention is configured to simulate signal transmission rate, thus the AV storage apparatus permits to transmit the audio and video signals to the exterior display apparatus for displaying.

2. The present invention operates with simple circuitry and software and is characterized in low manufacturing cost, thus economic loading of the users can be reduced.

The aforementioned detail description is for explaining a particular embodiment of the present invention, and the embodiment is not applied to limit the present invention. The equivalent embodiment of modification after understanding the present invention shall be within the scope of the invention.

As aforementioned, the present invention is novel in technology and advantaged in many effects that the prior arts lack. The present invention conforms to the novelty and non-obviousness of patentability. Please the examiner carefully considering the application of the present invention and allowing the application.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An audio/video (AV) signal access controlling apparatus comprising:
an exterior connector, being connected to an exterior AV storage apparatus;
a voltage level signal generator, being connected to the exterior connector, and being configured to provide a voltage level signal to the AV storage apparatus for voltage level comparison, wherein when the voltage level is correct, the AV storage device is configured to process signal communication with a controller;
a terminal set, the terminal set being connected to the exterior connector, and being configured to receive audio or video signals transmitted from the AV storage apparatus and display on an exterior display apparatus;
a controller, being connected to the exterior connector, wherein when the controller is configured to transmit signals to the AV storage apparatus, a delay of 51μ second (51 μs) is required for simulating a transmission rate of 19200 bps, thus the AV storage apparatus permits to transmit the audio and video signals back to the controller, and the controller is configured to control the transmission of the audio and video signals from the terminal set to the exterior display apparatus for displaying.

2. The AV signal access controlling apparatus as claimed in claim 1, further comprising a reset unit, the reset unit being connected to the controller, wherein the reset unit is configured to reset the controller to reactivate the controller when the controller is inactive.

3. The AV signal access controlling apparatus as claimed in claim 1, further comprising an oscillator, being connected to the controller, and being configured to oscillate the signal contained in each output signal set as a clock signal N for being outputted to the AV storage apparatus.

4. The AV signal access controlling apparatus as claimed in claim 1, wherein the terminal set comprises a S terminal, and the S terminal is configured to receive the S video signal from the AV storage apparatus for being displayed on the exterior display apparatus.

5. The AV signal access controlling apparatus as claimed in claim 1, wherein the terminal comprises a RCA terminal, and the RCA terminal is configured to receive the RCA audio and video signals from the AV storage apparatus for being displayed on the exterior display apparatus.

6. The AV signal access controlling apparatus as claimed in claim 1, wherein the terminal comprises a USB connector, and the USB connector is configured to receive the audio and video signals from the AV storage apparatus for being displayed on the exterior display apparatus.

7. The AV signal access controlling apparatus as claimed in claim 1, wherein the voltage level generator generates a voltage level by a 500KΩ resistor.

8. The AV signal access controlling apparatus as claimed in claim 1, wherein the controller comprises a first register, and the first register is configured to store a plurality of output signal sets Y.

9. The AV signal access controlling apparatus as claimed in claim 8, wherein each output signal set Y comprises a plurality of clock signals N, and the clock signal N is stored in a second register of the controller.
